(19) United States
(12) Patent Application Publication
(10) Pub. No.: US 2025/0007258 A1
(43) Pub. Date: Jan. 2, 2025

(54) WIRE STRIPPERS

(71) Applicant: KRAMPE IMMOBILIEN GMBH & CO. KG, Ascheberg (DE)

(72) Inventor: Carsten Bünningmann, Ascheberg-Herbern (DE)

(21) Appl. No.: 18/708,781

(22) PCT Filed: Nov. 4, 2022
(86) PCT No.: PCT/EP2022/080874

§ 371 Date: May 9, 2024

(30) Foreign Application Priority Data
Nov. 19, 2021 (DE) 20 2021 106 335.1

(51) Int. Cl. H02G 1/12

(52) U.S. Cl. CPC H02G 1/1212

(57) ABSTRACT

The present invention relates to a pair of wire strippers comprising a first handle (1) and a second handle (2), the first handle (1) including a first jaw (4) and the second handle (2) including a second jaw (6). In order for the pair of wire strippers to be able to be adapted to different wires in a last assembly step or after use, the first jaw (4) has a first insert (7) on which a first clamping element (21) and a first cutting element (20) are provided, the second jaw (6) has a second insert (7) on which a second clamping element (21) and a second cutting element (20) are provided, the first insert (7) is detachably connected to the first jaw (4) and the second insert (7) is detachably connected to the second jaw (6).

### CROSS-REFERENCE TO RELATED APPLICATIONS

This application is a National Stage Application under 35 U.S.C. § 371 of PCT Application No. PCT/EP2022/080874, filed Nov. 4, 2022, which claims priority to German Patent Application No. 20 2021 106 335.1, filed Nov. 19, 2021, the entire contents of which are incorporated by reference herein.

### BACKGROUND OF THE INVENTION

### 1. Field of the Invention

The present invention relates to a pair of wire strippers and an insert for a pair of wire strippers.

### 2. Description of the Related Art

Such a pair of wire strippers with a first and a second leg, wherein the first leg comprises a first handle and a first jaw, wherein the second leg comprises a second handle and a second jaw, wherein the first jaw has a first clamping element and a first cutting element, wherein the second jaw has a second clamping element and a second cutting element, is known from DE000009102476U1. The pair of wire strippers is designed such that the first and second clamping elements and the first and second cutting elements cannot be easily added, removed or replaced after the pair of wire strippers have been assembled.

A disadvantage of this pair of wire strippers is that it cannot be adapted in a final assembly step to the conductors for which the pair of wire strippers is to be used, and further, that different pairs of wire strippers must be used for different cables. Different pairs of wire strippers must be purchased for different cables. Further, it is not possible for a manufacturer to produce the pair of wire strippers almost completely, store them in stock and then adapt them to a customer's order in a final assembly step.

The present invention is based on the object of creating a pair of wire strippers and a corresponding insert which allow the pair of wire strippers to be adapted for use for different cables in a final assembly step or subsequently.

The object on which the invention is based is achieved by a pair of wire strippers with the features of the characterizing part of the claim 1 and an insert with the features of the characterizing part of the claim 6.

### SUMMARY OF THE INVENTION

The invention relates to a pair of wire strippers with a first and a second leg, wherein the first leg comprises a first handle and a first jaw, wherein the second leg comprises a second handle and a second jaw, wherein the first jaw has a first clamping element and a first cutting element, wherein the second jaw has a second clamping element and a second cutting element, wherein the first jaw has a first insert on which the first clamping element and the first cutting element are provided, wherein the second jaw has a second insert on which the second clamping element and the second cutting element are provided, wherein the first insert is detachably fastened to the first jaw, and wherein the second insert is detachably fastened to the second jaw. Preferably, the first leg and the second leg are connected to one another by a joint. Preferably, a cable to be stripped is clamped between the first and the second clamping element and is pulled backwards by them while a sheath of the cable is cut through between the first and the second cutting element. Advantageously, the first and the second insert can be detached and removed from the associated jaws and can each be replaced by an insert that is suitable for other cables, such that the pair of wire strippers can be used for different cables such as ribbon and round cables.

In a preferred embodiment, the first jaw has a first receiving recess for the first insert, and the second jaw has a second receiving recess for the second insert. Preferably, the first and second receiving recesses each have two side walls which delimit the receiving recess. Preferably, they each have in addition a rear wall which delimits the receiving recess. The dimensions of the receiving recesses are tailored to the inserts such that these have little play. With respect to the receiving recesses and inserts of the present invention, “front” is defined as a position at the free ends of the legs on which the associated jaw is formed, respectively. The first and second receiving recesses preferably also each have an outer wall, which delimits the receiving recess. The first and second receiving recesses preferably also each have a first and a second inner opening, respectively, into which the associated insert is inserted. With respect to the receiving recesses and inserts of the present invention, “outer” is defined as a position, which faces away from the other receiving recess and the other insert when the two jaws rest against each other with their cutting and clamping elements. Advantageously, the walls ensure secure positioning of the inserts.

In a development of the last-mentioned preferred embodiment, the first receiving recess has a first opening at the front of the tip of the first jaw, and the second receiving recess has a second opening at the front of the tip of the second jaw. Advantageously, the openings allow insertion and removal of the inserts from the front, such that a lot of space is not required between the jaws for this purpose.

In a further development of the last-mentioned preferred embodiment, a first positioning projection is provided in the first recess, wherein a first positioning indentation is provided on the first insert, into which the first positioning projection engages, wherein a second positioning projection is provided in the second recess, and wherein a second positioning indentation is provided on the second insert, into which the second positioning projection engages. Preferably, the positioning projections are each provided on the inside of the outer wall of the corresponding receiving recess.

In a further development of the last-mentioned preferred embodiment, a first screw is provided which connects the first insert to the first jaw, wherein the first screw runs through the first positioning projection, wherein a second screw is provided which connects the second insert to the second jaw, and wherein the second screw runs through the second positioning projection. Preferably, the heads of the screws are each accommodated in the associated positioning projection.

The invention further relates to an insert for a pair of wire strippers, wherein a clamping element and a cutting element are provided on the insert. Preferably, the insert has means, such as a threaded hole, to detachably fasten the insert to the jaw of pair of wire strippers.

In a preferred embodiment, the insert has two (preferably parallel) side walls, wherein the clamping element is hinged between the two side walls, and wherein the cutting element is hinged between the two side walls.

In a further development of the last-mentioned preferred embodiment, the insert has a rear reinforcement in which a positioning indentation, a threaded hole and a spring receptacle are provided for one end of a spring.

In another development of the last-mentioned preferred embodiment, a spring support web runs between the two side walls.

### BRIEF DESCRIPTION OF THE DRAWINGS

The invention is described in more detail below with reference to drawings. It is shown in:

FIG. 1A a perspective view of a pair of wire strippers;

FIG. 1B a side view of the pair of wire strippers;

FIG. 2A a perspective view of an insert;

FIG. 2B a sectional view of the insert;

FIG. 3 a side view of the second leg of the pair of wire strippers in section during assembly of the second insert; and

FIG. 4 a side view of the pair of wire strippers in section.

### DETAILED DESCRIPTION OF THE EMBODIMENTS

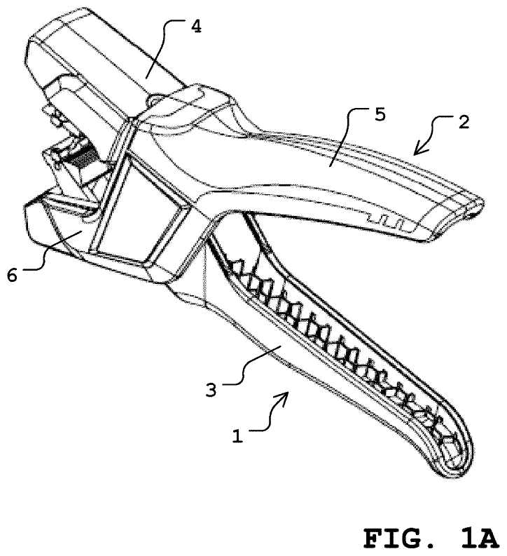

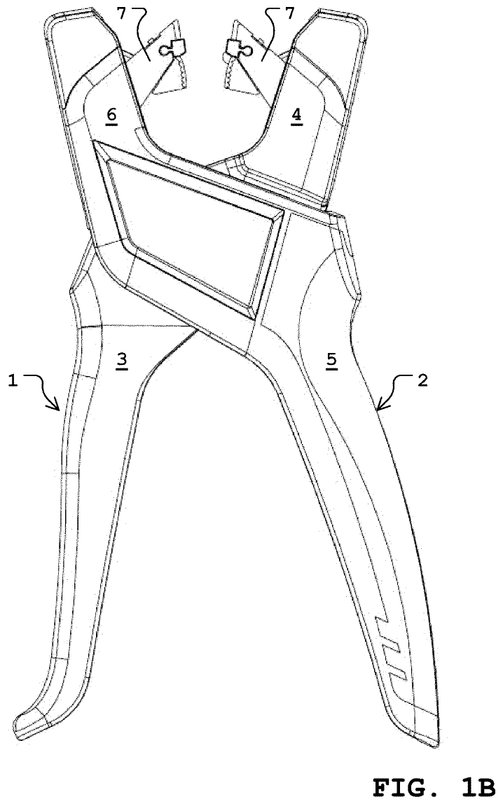

FIG. 1A and FIG. 1B show a perspective view and a side view of a pair of wire strippers. The pair of wire strippers comprise a first 1 and a second 2 leg, which are connected to one another by a joint (not shown) which comprises two stub shafts such that there is a central passage for a cable to be stripped. The first leg 1 comprises a first handle 3 and a first jaw 4. The second leg 2 comprises a second handle 5 and a second jaw 6. A first insert 7 is inserted into the first jaw 4. A second insert 7 is inserted into the second jaw 6. Identical reference signs are used here and in the following for the two inserts which are formed mirror-inverted in order to achieve a favourable distribution of forces when interacting, their analogous features and analogous components and for the associated receiving recesses and their analogous features.

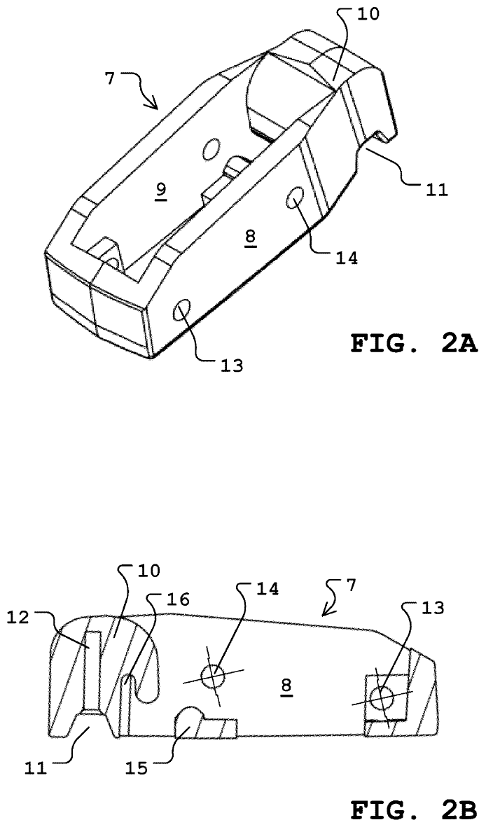

FIG. 2A and FIG. 2B show a perspective view and a sectional view of an insert 7, respectively, which is illustrated without the associated clamping element and the associated cutting element in order not to distract from the features which are important for the assembly of the insert. The insert 7 has a rectangular base and has a first side wall 8 and a second side wall 9, which laterally delimit a cavity. At the rear end of the insert 7, a reinforcement 10 is formed, on which a positioning indentation 11 is provided, into which a threaded hole 12 opens. In the front area, a hole 13 is provided in each of the side walls 8, 9 opposite each other for the passage of a pin in order to fasten the clamping element in an articulated manner. In the central area, a hole 14 is provided in each of the side walls 8, 9 opposite each other for the passage of a pin in order to fasten the cutting element in an articulated manner. A spring support web 15 runs below the holes 14. A spring receptacle 16 for one end of a spring is also provided on the reinforcement.

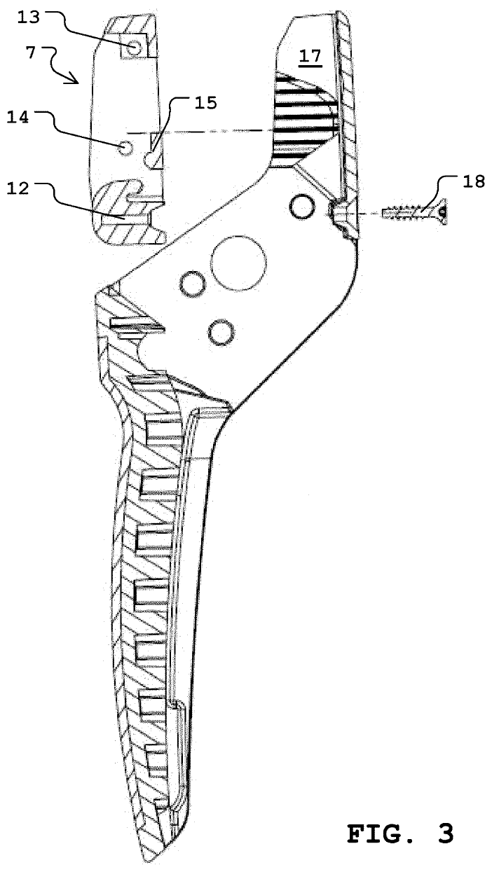

FIG. 3 shows a side view of the second leg 2 of the pair of wire strippers in section during the assembly of the second insert 7, which is also illustrated without the associated clamping element and the associated cutting element in order not to distract from the features which are important for the assembly of the second insert 7. The second insert 7 is inserted into a second receiving recess 17 of the second jaw 6. Since the receiving recess 17 is open inside and at the front, the second insert 7 can be inserted from the inside but also from the front, for example, if the pair of wire strippers is already assembled and the first insert is already mounted, such that there is little space between the two jaws. The second insert 7 is then fastened by means of a first screw 18, which is guided through a screw hole in the outer wall of the second jaws 6. The first leg differs from the second leg 2 essentially in that it is enclosed by the first leg at a common joint.

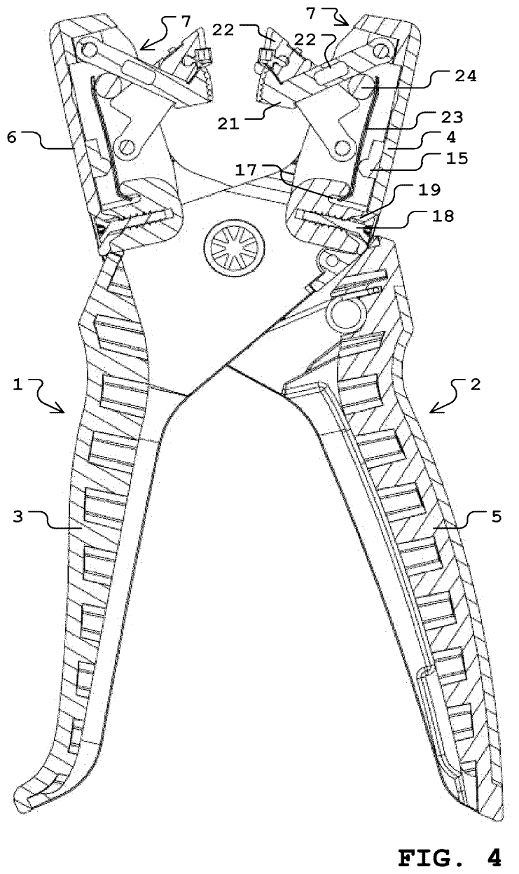

FIG. 4 shows a side view of the pair of wire strippers in section. The first and second inserts 7, 7 are inserted into the corresponding receiving recesses of the first 4 and the second 6 jaw, respectively. The inserts 7, 7 are each positioned by means of a positioning indentation, into which a corresponding positioning projection 19 engages, which is formed on an outer wall of the associated receiving recess. The inserts 7, 7 are each fastened by a screw 18, the head of which is received in the corresponding positioning projection 19 and the thread of which is screwed into the threaded hole of the corresponding insert 7. A cutting element 20 and a clamping element 21 are provided in each insert 7,7. The cutting element 20 comprises an arm which, at one end, is rotatable about a pin passing through and being secured in the two opposite holes 14 (see FIGS. 2A and 2B), and, at the other end of the arm, a head on which a cutting edge is formed. The clamping element 21 comprises an arm which, at one end, is rotatable about a pin passing through and being secured in the two opposite holes 13 (see FIGS. 2A and 2B), and, at the other end of the arm, a head on which a clamping surface is formed. The cutting element 20 and the clamping element 21 cross each other. Their opposing movements are synchronized in that a burl (not shown) of the clamping element 21 runs in an elongated hole 22 of the cutting element 20. A spring 23, which is fastened at one end in the spring receptacle 16 and is supported on the spring support web 1, acts on a cylindrical pressing element 24, which in turn acts on the arms of the cutting element 20 and the clamping element 21. This mechanism and its interaction are already known from DE000009102476U1 and other disclosures. The present invention is characterized by how the elements of the mechanism are arranged in the inserts 7.

### LIST OF REFERENCE NUMERALS

1 first leg
2 second leg
3 first handle
4 first jaw
5 second handle
6 second jaw
7 second insert
8 first side wall
9 second side wall
10 reinforcement
11 positioning indentation
12 threaded hole
13 hole
14 hole
15 spring support web
16 spring receptacle
17 receiving recess
18 screw
19 positioning projection
20 cutting element
21 clamping element
22 elongated hole
23 spring
24 pressing element

1. A pair of wire strippers with a first (1) and a second (2) leg, wherein the first leg (1) comprises a first handle (3) and a first jaw (4), wherein the second leg (2) comprises a second handle (5) and a second jaw (6), wherein the first jaw (4) has a first clamping element (21) and a first cutting element (20), wherein the second jaw (6) has a second clamping element (21) and a second cutting element (20), wherein the first jaw (4) has a first insert (7) on which the first clamping element (21) and the first cutting element (20) are provided, in that the second jaw (6) has a second insert (7) on which the second clamping element (21) and the second cutting element (20) are provided, in that the first insert (7) is detachably fastened to the first jaw (4), and in that the second insert (7) is detachably fastened to the second jaw (6).

2. The pair of wire strippers according to claim 1, wherein the first jaw (4) has a first receiving recess (17) for the first insert (7), and in that the second jaw (6) has a second receiving recess (17) for the second insert (7).

3. The pair of wire strippers according to claim 2, wherein the first receiving recess (17) has a first opening at the front of the tip of the first jaw (4), and in that the second receiving recess (17) has a second opening at the front of the tip of the second jaw (6).

4. The pair of wire strippers according to claim 2, wherein a first positioning projection (19) is provided in the first receiving recess (17), in that a first positioning indentation (11) is provided on the first insert (7), into which the first positioning projection (19) engages, in that a second positioning projection (19) is provided in the second receiving recess (17), and in that a second positioning indentation (11) is provided on the second insert, into which the second positioning projection (19) engages.

5. The pair of wire strippers according to claim 4, wherein a first screw (18) is provided which connects the first insert (7) to the first jaw (4), and in that the first screw (18) runs through the first positioning projection (19), and in that a second screw (18) is provided which connects the second insert (7) to the second jaw (6), and in that the second screw (18) runs through the second positioning projection (19).

6. An insert (7) for a pair of wire strippers, wherein a clamping element (21) and a cutting element (20) are provided on the insert (7).

7. The insert (7) according to claim 6, wherein the insert (7) has two side walls (8, 9), in that the clamping element (21) is fastened in an articulated manner between the two side walls (8, 9), and in that the cutting element (20) is fastened in an articulated manner between the two side walls (8, 9).

8. The insert (7) according to claim 6, wherein the insert (7) has a rear reinforcement (10) in which a positioning indentation (11), a threaded hole (12) and a spring receptacle (16) are provided for one end of a spring (23).

9. The insert (7) according to claim 8, wherein a spring support web (15) runs between the two side walls (8, 9).
